(19) United States
(12) Patent Application Publication
(10) Pub. No.: US 2017/0280310 A1
(43) Pub. Date: Sep. 28, 2017

(54) METHODS AND SYSTEMS FOR CONTROLLING EXTERNAL ACCESS TO A COMMUNCATIONS PORT

(71) Applicant: QUALCOMM Incorporated, San Diego, CA (US)

(72) Inventors: Amit Jain, San Diego, CA (US); Govind Ram Venkat Narayan, San Diego, CA (US); Santosh Munirathna, San Diego, CA (US)

(21) Appl. No.: 15/080,456

(22) Filed: Mar. 24, 2016

(51) Int. Cl. H04W 4/22; H04W 48/08

(52) U.S. Cl. CPC H04W 4/22; H04W 48/08

(57) ABSTRACT

Disclosed are methods and systems for providing control over a port, such as a port utilizing the User Datagram Protocol, for example, in a mobile device. In a particular implementation, a mobile device user may select to close or otherwise restrict access to the port, which may thus prevent a user external to the cellular communications network from obtaining the user's present location and/or from hindering operations of the mobile device. Upon detection of an event, the port may be reopened, which may thereby permit a cellular communications network to determine an estimate of the mobile device user's location responsive to, for example, the user placing an E911 emergency call.

### BACKGROUND

Field

Embodiments described herein are directed to providing control over one or more communications ports of a mobile communications device.

Information

The global positioning system (GPS), and other like satellite and terrestrial positioning systems, have enabled navigation services for mobile communications devices in outdoor environments. Likewise, particular techniques for obtaining estimates of a position of a mobile communications device may enable enhanced location-based services in particular indoor venues such as residential, governmental, or commercial venues. In particular applications, location-based services may support one or more emergency services, such as dispatching emergency response resources, for example, to an estimated location of a mobile device. In some systems, an accurate estimated location of a mobile device may be obtained using GPS or other positioning techniques by way of a positioning session, in which components of a wireless communications network may cooperate with a mobile device to estimate a location of the mobile communications device. However, at least in some instances, a communications port of a mobile device, which may be utilized to cooperatively assist in providing emergency services to a mobile device user, may also be utilized by a malicious entity, for example, to damage and/or hinder operations of the mobile device.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a system diagram illustrating certain features of a system containing a mobile device, in accordance with an implementation.

FIG. 2 is a schematic diagram of an architecture of a cellular communications network capable of supporting emergency services according to an embodiment.

FIG. 3A is a message flow diagram illustrating an approach to providing positioning operations in a user plane location solution according to an embodiment.

FIG. 3B is a message flow diagram illustrating an approach toward discarding malicious or suspect SUPL-INIT messages responsive to a UDP port of a mobile device operating in a closed or restricted state according to an embodiment.

FIG. 4 is a flow diagram for a method of controlling external access to a communications port according to a simplified embodiment.

FIG. 5 is a flow diagram for a method of controlling external access to a communications port according to an embodiment.

FIGS. 6A-6B are schematic diagrams of a display of a mobile device showing location access selection and an indication showing status of a location access feature according to an embodiment.

FIG. 7 is a flow diagram for a method for controlling external access to a communications port according to an embodiment.

FIG. 8 is a schematic diagram of a mobile device, mobile station, UE, subscriber equipment or target device shown in FIG. 1-FIG. 3 according to an embodiment.

FIG. 9 is a schematic diagram illustrating an example system 900 that may include one or more devices configurable to execute the methods described, for example, in FIGS. 4 and 5.

### SUMMARY

Briefly, a particular implementation may be directed to a method to control external access to a communications port at a mobile device. The method may comprise restricting processing of one or more messages received at the communications port of the mobile device from a wireless communications channel, and, responsive to detection of an event at the mobile device, enabling the processing of the one or more messages received at the communications port, the event to comprise an emergency event, a change in a device setting or combination thereof.

Another embodiment may be directed to a mobile device to support location services. The mobile device may comprise a transceiver device to wirelessly receive one or more messages from a communications network and to transmit messages to a communications network. The mobile device may further comprise one or more processors coupled to the transceiver device and configured to: initiate one or more restrictions on processing of the one or more messages received by the transceiver device from a wireless communications channel via a communications port of the mobile device; and to initiate removal of the one or more restrictions on the processing of one or more messages received via the communications port based, at least in part, on detection of an event at the mobile device. In embodiments, the event may comprise an emergency event, a change in a device setting or a combination thereof.

Another embodiment may be directed to a mobile device to control external access to a communications port. The mobile device may comprise means for restricting processing of one or more messages received from a wireless communications channel at a communications port of the mobile device, and means for removing restrictions on the processing of one or more messages received at the communications port based, at least in part, on detection of an event at the mobile device. The event may comprise an emergency event or a change in a device setting, or combination thereof.

Another embodiment may be directed to a non-transitory storage medium comprising instructions executable by a special-purpose computing apparatus of a mobile device to restrict processing of one or more messages received at the mobile device from a wireless communications channel at a communications port of the mobile device. Responsive to detection of an event at the mobile device, the special-purpose computing apparatus may remove the restriction on the processing of the one or more messages received at the communications port, in which the event may comprise an emergency event, a change in a device setting or a combination thereof.

It should be understood that the aforementioned implementations are merely example implementations, and that claimed subject matter is not necessarily limited to any particular aspect of these example implementations.

### DETAILED DESCRIPTION

Multiple Public Safety Answering Points may be utilized to provide emergency services, such as emergency service personnel and/or other resources, to mobile device users that may be spread over a large geographical area. Thus, if a mobile device user places an emergency call, the call may be routed to a particular Public Safety Answering Point (PSAP), for example, responsible for a specific portion of a geographical area. Accordingly, location estimation of mobile device users should be completed in a timely manner so that appropriate emergency-services operators may expeditiously assess the needs and the nature of the emergency call. If the location of the mobile device user requesting assistance can be quickly estimated, emergency assistance resources can be expeditiously allocated and transported to the location of the mobile device user placing the emergency call.

In particular embodiments, a mobile device may be equipped with circuitry and processing resources, which may permit the mobile device to obtain location estimations using, for example, signals acquired from a global navigation satellite system, for example, and/or utilizing signals acquired from terrestrial transmitters, such as cellular base stations. Thus, responsive to a mobile device user dialing, for example, “911” in the United States or, for example, dialing “999” in the United Kingdom, a location services client within a cellular network infrastructure, which may comprise a PSAP, for example, may initiate a positioning session to facilitate location estimation of a mobile device. In this context, location estimation may be facilitated utilizing a connection-based “control plane” solution that refers to an exchange of signaling messages over interfaces utilizing signaling protocols that are supported for normal cellular network operation as well as for location determination.

Alternatively, responsive to receipt of an E911 call, a cellular service provider may trigger a positioning session utilizing a “connectionless” protocol, such as, for example, a User Datagram Protocol (UDP) by way of a binary digital signal connection to a cellular communications network. In this context, the term “connectionless” protocol refers to communication among one or more network elements of a cellular communications network and a mobile device, wherein messages may be encoded into datagrams and conveyed to the mobile device. In embodiments, communications utilizing a connectionless protocol may entail routing messages to a mobile device address, for example, without providing advance notice to the mobile device that any type of communications is imminent. Also in this context, the term “user plane” refers to an exchange of user-generated content, such as, location protocol generated messages, text messages, as well as other forms of content encoded utilizing, for example, an Internet protocol (IP), a transmission control protocol (TCP) and/or user datagram protocol (UDP).

In embodiments, if a positioning session is to be conducted utilizing a user plane, location parameters may be encoded into datagrams and conveyed to recipient, such as a mobile device, utilizing an emergency Secure User Plane Location (SUPL) platform, for example, defined by the Open Mobile Alliance (OMA) and standard control plane location solutions defined by 3GPP and 3GPP2. A mobile device may initiate a positioning session responsive to, for example, receipt of a Secure User Plane Location-Initiate (SUPL-INIT) message, which may be generated by an element within the cellular infrastructure responsive to receipt of an E911 emergency call placed from the mobile device.

In particular embodiments, to conduct a positioning session utilizing a user plane, it may be beneficial to maintain a UDP port in an “open” state, in which a UDP port is capable of receiving messages from elements within a cellular communications network. Such maintenance of a UDP port in an open state may, for example, permit a mobile device to participate in a positioning session, at substantially all times, for example, so as to be capable of acquiring, for example, a SUPL-INIT message from a network element within the cellular infrastructure. Thus, in an attempt to ensure that the mobile device is available to cooperate in a positioning session responsive to placing an E911 call, a UDP port of a mobile device may be placed in an open state during all times of operation, or during substantially all times of operation. In embodiments, a UDP port of a mobile device may remain in an open state even during times at which the mobile device is not be actively engaged in a telephone call, for example.

However, although maintaining a UDP port of a mobile device in an open state during substantially all times of operation may permit the mobile device to cooperate in a positioning session, such maintaining may also expose the mobile device to certain undesirable security vulnerabilities. For example, in one possible scenario, if a malicious user, perhaps operating a laptop computer from a remote location, such as a remote location outside of a cellular communications network, obtains an Internet protocol (IP) address of a mobile device, the malicious user may generate message traffic that may hinder or impede operation of the mobile device. In one instance, a malicious user may generate a large number (e.g., approximately 1000, 2000, or a greater number, without limitation) of messages that may operate to inundate the mobile device with messages sufficient in number to render the mobile device incapable of performing normal functions. Accordingly, a mobile device user attempting to load a digital map to obtain routing assistance to a destination, for example, may experience a delay in obtaining such assistance. In other examples, a mobile device user attempting to place an ordinary phone call, or to send and/or receive, for example, text messages, may find the mobile device unable to provide such services. In at least one scenario, receipt of a large number of messages by way of a UDP port may render the UDP port unavailable for processing legitimate network-initiated SUPL-INIT messages, for example, which may hinder or delay delivery of emergency services.

In another scenario, a mobile device user may wish to keep his or her location relatively private. For example, certain mobile device users may be fearful that knowledge of their personal and immediate whereabouts may expose them to an increased risk of criminal activity, personal injury, or may represent one or more other sources of risk of undesirable consequences. Accordingly, mobile device users may have a genuine need to close a UDP port of a mobile device, for example, to external traffic, or to at least occasionally restrict access to a UDP port. However, at least in some embodiments, a mobile device user may wish, for example, to quickly reopen a closed UDP port, or may wish to easily restore relatively unrestricted access to a UDP port. In embodiments, restore relatively unrestricted access to a UDP port may permit the mobile device user to place an E911 telephone call, for example, and to obtain emergency services responsive to placement of an emergency call.

Accordingly, in certain embodiments, a mobile device may comprise a capability for a user to exert control over the state of, for example, a “controllable” UDP port of a mobile device. In this context, control of a UDP port of a mobile device may be facilitated by a third-party utility or plug-in, for example, operating at an application layer, that may dynamically open the UDP port so as to permit the user to eavesdrop or record parameters, such as mobile device location parameters, for example.

In particular embodiments, a utility or plug-in may additionally permit a processor of the mobile device to restrict messages received via a UDP port. Thus, in particular embodiments, “restricted” processing of received messages may operate to permit certain types of messages to be received and processed by one or more processors of, for example, a mobile device. Restricting processing of received messages may also refer to blocking certain other types of messages such as messages transmitted by malicious users attempting to hinder operation of the device. Accordingly, restricting processing of received messages may bring about discarding of received messages that originate, for example, from locations outside of a cellular communications network and/or may refer to discarding messages that do not comprise certain types of headers, while admitting messages that comprise other types of headers, for example. In particular embodiments, restricting processing may refer to blocking of certain messages that do not comprise a one or more predetermined codewords, for example.

Restricting access to a UDP port may also enhance a mobile device user's privacy by restricting an ability to obtain the mobile device user's estimated location. In particular embodiments, access to a UDP port may be restricted, for example, to certain types of messages, such as network-initiated SUPL-INIT messages received via a UDP port. Responsive to certain events, such as an emergency event and/or condition, a mobile device may open or remove restrictions imposed on a UDP port, which may thereby permit the port to receive message traffic, such as a network-initiated SUPL-INIT message.

Thus, by permitting a user to exert control over a mobile device's UDP port, a mobile device user may reduce a likelihood of a malicious user interfering with the mobile device's operations, for example, by inundating a UDP port with unwanted and/or useless message traffic. Additionally, for those individuals who may place a premium on personal security and/or privacy, exerting control over a mobile device's UDP port may bring about degree of confidence and peace of mind that the mobile device user is not being surreptitiously tracked. Further, if location services are needed, the mobile device user can be assured location services can be provided, for example, by way of a simple modification to one or more mobile device settings.

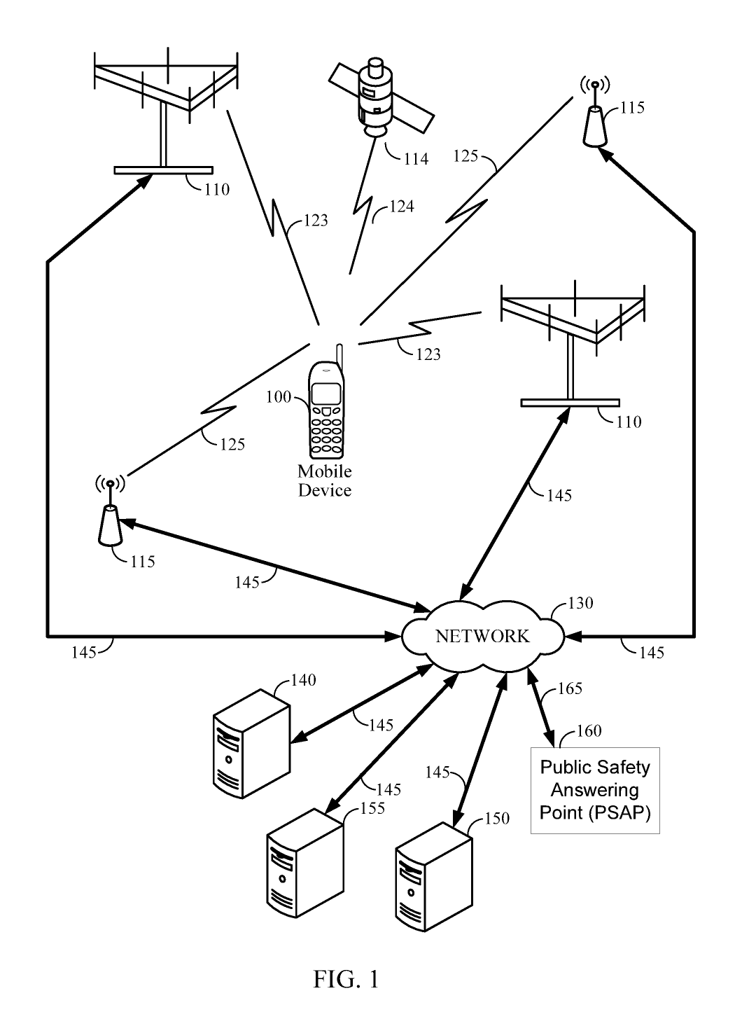

FIG. 1 is a system diagram illustrating certain features of a system comprising a mobile device, in according to an embodiment. As shown in FIG. 1 in a particular implementation, mobile device 100, which may also be referred to as a UE (or user equipment), may transmit radio signals to, and receive radio signals from, a wireless communications network. In one example, mobile device 100 may communicate with a cellular communications network by transmitting wireless signals to, and/or receiving wireless signals from, a cellular transceiver 110, which may comprise a wireless base transceiver subsystem (BTS), a Node B or an evolved NodeB (eNodeB), over wireless communication link 123. Similarly, mobile device 100 may transmit wireless signals to, and/or receive wireless signals from, local transceiver 115 over wireless communication link 125. A local transceiver 115 may comprise an access point (AP), femtocell, Home Base Station, small cell base station, Home Node B (HNB) or Home eNodeB (HeNB) and may provide access to a wireless local area network (WLAN, e.g., IEEE 802.11 network), a wireless personal area network (WPAN, e.g., Bluetooth® network) or a cellular network (e.g. an LTE network or other wireless wide area network, such as those discussed in the next paragraph). Of course, it should be understood that these are merely examples of networks that may communicate with a mobile device over a wireless link, and claimed subject matter is not limited in this respect.

Examples of network technologies that may support wireless communication link 123 are Global System for Mobile Communications (GSM), Code Division Multiple Access (CDMA), Wideband CDMA (WCDMA), Long Term Evolution LTE), High Rate Packet Data (HRPD). GSM, WCDMA and LTE are technologies defined by 3GPP. CDMA and HRPD are technologies defined by the 3^{rd} Generation Partnership Project 2 (3GPP2). WCDMA is also part of the Universal Mobile Telecommunications System (UMTS) and may be supported by an HNB. Cellular transceivers 110 may comprise deployments of equipment providing subscriber access to a wireless telecommunication network for a service (e.g., under a service contract). Here, a cellular transceiver 110 may perform functions of a cellular base station in servicing subscriber devices within a cell determined based, at least in part, on a range at which the cellular transceiver 110 is capable of providing access service. Examples of radio technologies that may support wireless communication link 125 are IEEE 802.11, Bluetooth (BT) and LTE.

In a particular implementation, cellular transceiver 110 and local transceiver 115 may communicate with servers 140, 150 and/or 155 over a network 130 through links 145. Here, network 130 may comprise any combination of wired or wireless links and may include cellular transceiver 110 and/or local transceiver 115 and/or servers 140, 150 and 155. In a particular implementation, network 130 may comprise Internet Protocol (IP) or other infrastructure capable of facilitating communication between mobile device 100 and servers 140, 150 or 155 through local transceiver 115 or cellular transceiver 110. In an embodiment, network 130 may also facilitate communication between mobile device 100, servers 140, 150 and/or 155 and a public safety answering point (PSAP) 160, for example through communications link 165. In another implementation, network 130 may comprise a cellular communication network infrastructure such as, for example, a base station controller or packet based or circuit based switching center (not shown) to facilitate mobile cellular communication with mobile device 100. In a particular implementation, network 130 may comprise local area network (LAN) elements such as WiFi APs, routers and bridges and may, in such an instance, comprise links to gateway elements that provide access to wide area networks such as the Internet. In other implementations, network 130 may comprise a LAN and may or may not involve access to a wide area network but may not provide any such access (if supported) to mobile device 100. In some implementations, network 130 may comprise multiple networks (e.g., one or more wireless networks and/or the Internet). In one implementation, network 130 may include one or more serving gateways or Packet Data Network gateways. In addition, one or more of servers 140, 150 and 155 may be an E-SMLC, a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs) of network 130.

In particular embodiments, communications between mobile device 100 and cellular transmitter 110, satellite 114, local transceiver 115, and so forth may occur utilizing signals communicated across wireless communications channels. Accordingly, the term “signal” may refer to communications utilizing propagation of electromagnetic waves across wireless communications channels. Signals may be modulated to convey messages utilizing one or more techniques such as amplitude modulation, frequency modulation, binary phase shift keying (BPSK), quaternary phase shift keying (QPSK) along with numerous other modulation techniques, and claimed subject matter is not limited in this respect. Accordingly, as used herein, the term “messages” refers to parameters, such as binary signal states, which may be encoded in a signal using one or more of the above-identified modulation techniques.

In particular implementations, and as discussed below, mobile device 100 may comprise circuitry and processing resources capable of obtaining location related measurements (e.g. for signals received from GPS or other Satellite Positioning System (SPS) satellites 114), cellular transceiver 110 or local transceiver 115 and possibly computing a position fix or estimated location of mobile device 100 based on these location related measurements. In some implementations, location related measurements obtained by mobile device 100 may be transferred to a location server such as an enhanced serving mobile location center (E-SMLC) or SUPL location platform (SLP) (e.g. which may be one of servers 140, 150 and 155) after which the location server may estimate or determine an estimated location for mobile device 100 based on the measurements. In the presently illustrated example, location related measurements obtained by mobile device 100 may include measurements of signals (124) received from satellites belonging to an SPS or Global Navigation Satellite System (GNSS) such as GPS, GLONASS, Galileo or Beidou and/or may include measurements of signals (such as 123 and/or 125) received from terrestrial transmitters fixed at known locations (e.g., such as cellular transceiver 110).

Mobile device 100 or a separate location server may obtain a location estimate for mobile device 100 based on location related measurements using any one of several position methods such as, for example, GNSS, Assisted GNSS (A-GNSS), Advanced Forward Link Trilateration (AFLT), Observed Time Difference Of Arrival (OTDOA) or Enhanced Cell ID (E-CID) or combinations thereof. In some of these techniques (e.g. A-GNSS, AFLT and OTDOA), pseudoranges or timing differences may be measured at mobile device 100 relative to three or more terrestrial transmitters fixed at known locations or relative to four or more satellites with accurately known orbital data, or combinations thereof, based at least in part, on pilots, positioning reference signals (PRS) or other positioning related signals transmitted by the transmitters or satellites and received at mobile device 100. Here, servers 140, 150 or 155 may be capable of providing positioning assistance data to mobile device 100 including, for example, information regarding signals to be measured (e.g., signal timing), locations and identities of terrestrial transmitters and/or signal, timing and orbital information for GNSS satellites to facilitate positioning techniques such as A-GNSS, AFLT, OTDOA and E-CID. For example, servers 140, 150 or 155 may comprise an almanac to indicate locations and identities of cellular transceivers and/or local transceivers in a particular region or regions such as a particular venue, and may provide information descriptive of signals transmitted by a cellular base station or AP such as transmission power and signal timing. In the case of E-CID, a mobile device 100 may obtain measurements of signal strengths for signals received from cellular transceiver 110 and/or local transceiver 115 and/or may obtain a round trip signal propagation time (RTT) between mobile device 100 and a cellular transceiver 110 or local transceiver 115. A mobile device 100 may use these measurements together with assistance data (e.g. terrestrial almanac data or GNSS satellite data such as GNSS Almanac and/or GNSS Ephemeris information) received from a server 140, 150 or 155 to determine a location estimate for mobile device 100 or may transfer the measurements to a server 140, 150 or 155 to perform the same determination. A call from mobile device 100 may be routed, based on the location of mobile device 100, and connected to a Public Safety Answering Point (PSAP) 160, for example, via wireless communication link 123 and communications link 165. PSAP 160 may, in an embodiment, correspond to PSAP 218 or legacy PSAP 220.

A mobile device (e.g., mobile device 100 of FIG. 1) may be referred to as a wireless device, a mobile terminal, a terminal, a mobile station (MS), a user equipment (UE), a SUPL Enabled Terminal (SET) or by some other name and may correspond to a cellphone, smartphone, laptop, tablet, PDA, tracking device or some other portable or moveable device. Typically, though not necessarily, a mobile device may support wireless communication such as using GSM, WCDMA, LTE, CDMA, HRPD, WiFi, BT, WiMax, etc. A mobile device may also support wireless communication using a wireless LAN (WLAN), DSL or packet cable for example. A mobile device may comprise a single entity or may comprise multiple entities such as in a personal area network where a user may employ audio, video and/or data I/O devices and/or body sensors and a separate wireline or wireless modem. An estimate of a location of a mobile device (e.g., mobile device 100) may be referred to as a location, location estimate, location fix, fix, position, position estimate or position fix, and may be geographic, thus providing location coordinates for the mobile device (e.g., latitude and longitude) which may or may not include an altitude component (e.g., height above sea level, height above or depth below ground level, floor level or basement level).

Alternatively, an estimated location of a mobile device may be expressed as a civic location (e.g., as a postal address or the designation of some point or small area in a building such as a particular room or floor). An estimated location of a mobile device may also be expressed as an area or volume (defined either geographically or in civic form) within which the mobile device is expected to be located with some probability or confidence level (e.g., 67% or 95%). An estimated location of a mobile device may further be a relative location comprising, for example, a distance and direction or relative X, Y (and Z) coordinates defined relative to some origin at a known location which may be defined geographically or in civic terms or by reference to a point, area or volume indicated on a map, floor plan or building plan. In the description contained herein, the use of the term location may comprise any of these variants unless indicated otherwise.

The architecture of the cellular communications network described in relation to FIG. 1 may be considered to comprise a generic architecture that capable of accommodating a variety of outdoor and indoor location solutions including the standard SUPL user plane location solution defined by the Open Mobile Alliance (OMA) and standard control plane location solutions defined by 3GPP and 3GPP2. For example, server 140, 150 or 155 may function as (i) a SUPL location platform to support the SUPL location solution, (ii) an E-SMLC to support the 3GPP control plane location solution with LTE access on wireless communication link 123 or 125, or (iii) a Standalone Serving Mobile Location Center (SAS) to support the 3GPP Control Plane Location solution for UMTS.

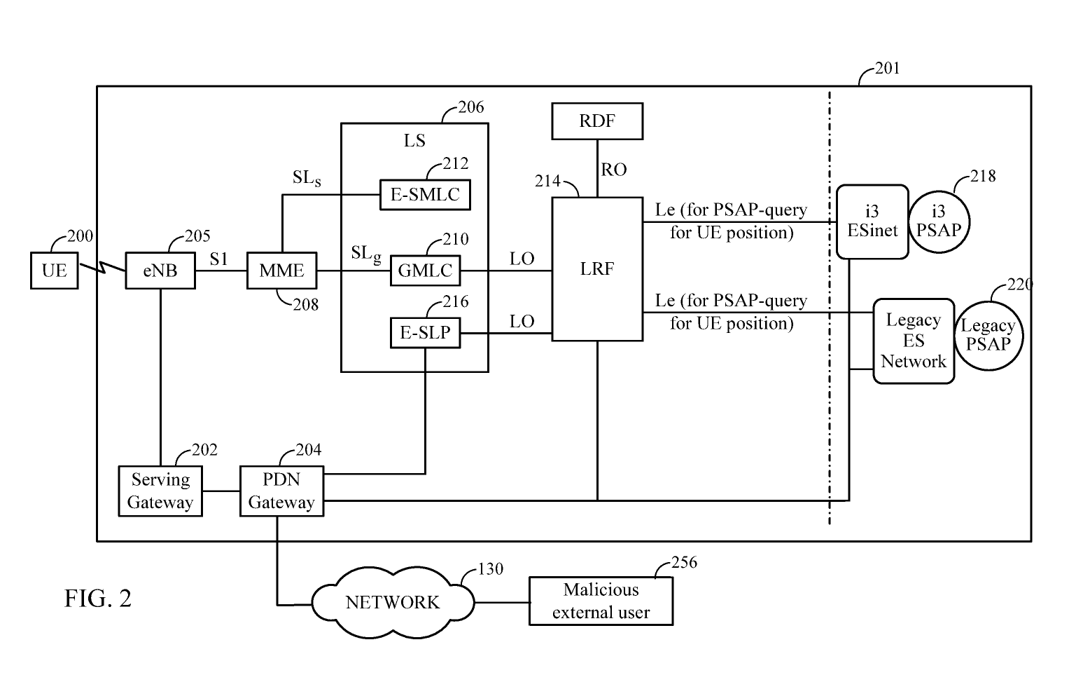

FIG. 2 is a schematic diagram of an architecture of cellular communications network 201, which may support emergency services calls (e.g., E911 calls) and location estimation of UE 200 placing an emergency services call on an LTE serving network according to an embodiment. Here, and as described in particular implementations below, location of UE 200 placing an emergency services call may be supported with a user plane location solution such as the OMA SUPL solution using a serving gateway 202 and packet data network (PDN) gateway 204 to support TCP/IP transport of SUPL messages between UE 200 and an Emergency SUPL Location Platform (E-SLP) 216 functioning as a location server (LS) 206. In this context, UE 200 may facilitate a user plane location solution using an exchange of messages in transactions occurring in entities typically accessible for services such as voice and data through eNB 205, serving gateway 202, and PDN gateway 204.

In a particular implementation, a location retrieval function (LRF) 214 may initiate determination of an estimated location of UE 200 in response to receiving an emergency event, for example, if LRF 214 receives an emergency service call request in a Session Initiation Protocol (SIP) INVITE message sent from UE 200 to initiate the emergency call. As enabled by the cellular communications network shown in FIG. 2, according to a particular implementation, LRF 214 may first attempt to initiate one or more positioning sessions via a user plane location solution to obtain a position fix for UE 200. Here, for example, LRF 214 may transmit a location request message to E-SLP 216 (e.g., an Emergency Location Immediate Request message defined according to the Open Mobile Alliance Mobile Location Protocol (OMA MLP)). E-SLP 216 may, in turn, attempt to initiate a SUPL positioning session with UE 200, via a UDP port utilizing a connectionless protocol, for example, and return a location estimate obtained for UE 200 to LRF 214. If E-SLP 216 is unable to return a location estimate for UE 200 to LRF 214 within some desired time limit and possibly after repeating a location estimation request for UE 200 to E-SLP 216 one or more additional times, LRF 214 may attempt to initiate one or more positioning sessions via an alternative approach, such as utilizing a control plane location solution. Utilizing a control plane location solution, LRF 214 may transmit a location request message to GMLC 210 (e.g., an Emergency Location Immediate Request message defined according to MLP) to initiate a series of messages among GMLC 210, UE 200, MME 208, eNB 205 and E-SMLC 212 to obtain a position fix for UE 200 according to the control plane location solution defined by 3GPP for LTE in 3GPP TS 23.271 and TS 36.305.

FIG. 2 also illustrates malicious external user 256 operating outside of cellular communications network 201. Malicious user 256 may operate, for example, utilizing a laptop computer, desktop computer, smart phone, or any other client device, for example, from a remote location by way of network 130, which may comprise the Internet, for example. In particular embodiments, malicious user 256 may have knowledge of an Internet Protocol (IP) address of UE 200. Thus, malicious user 256 may attempt to surreptitiously determine a location estimate of UE 200, such as by way of initiating a positioning session, so as to endanger a user of UE 200, for example. In other embodiments, malicious user 256 may simply be attempting to hinder, or even completely disable, operation of UE 200 by inundating a UDP port of UE 200 with potentially useless messages sufficient in number to render UE 200 incapable of performing normal functions.

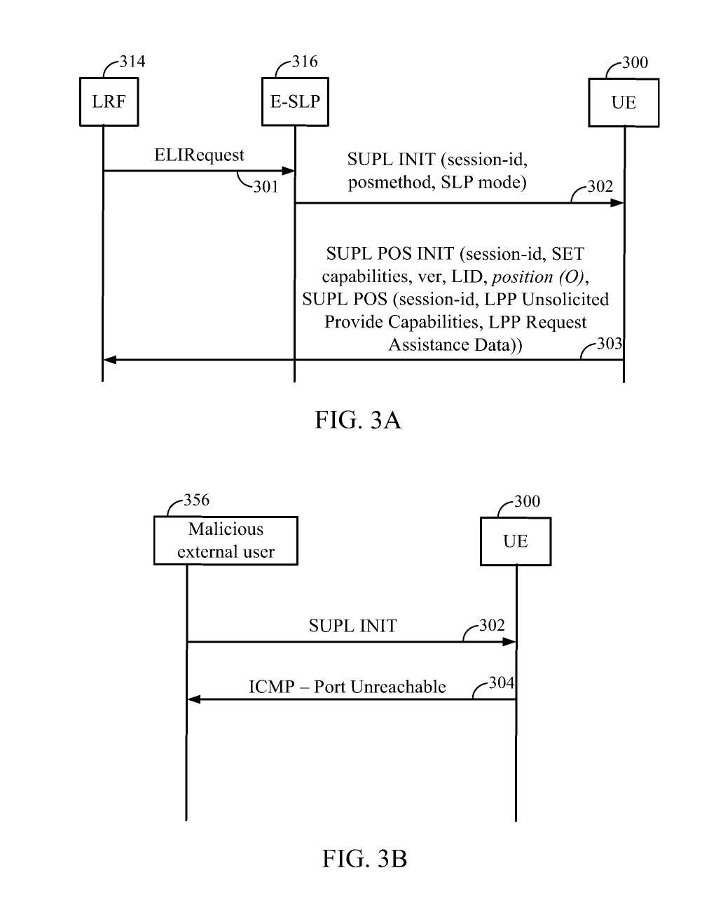

FIG. 3A is an abbreviated message flow diagram illustrating an approach to support positioning operations in the user plane location solution according to an embodiment. In FIG. 3A, UE 300 may correspond to UE 200 of FIG. 2 and E-SLP 316 may correspond E-SLP 216 of FIG. 2. In FIG. 3A, responsive to a request message 301 (e.g., an MLP Emergency Immediate Location Request or ELIRequest) from LRF 214 in the LTE network serving a UE 300 (e.g., acting as a SET) that has placed an E911 call, for example, E-SLP 316 may transmit a SUPL INIT message 302 to UE 300. Responsive to receipt of a SUPL INIT to instigate a SUPL session, UE 300 may establish a positioning session with E-SLP 316 to permit E-SLP 316 to obtain an estimated location of UE 300. UE 300 may transmit SUPL POS INIT message 303 to E-SLP 316 including a LID parameter (e.g., LocationID parameter), for example. In some embodiments, a cell ID based position fix (e.g., based on the received LID parameter) may be provided by E-SLP 316 for use by LRF 314. UE 300, E-SLP 316, and LRF 314 may exchange a number of additional messages among one another, and claimed subject matter is not limited in this regard.

FIG. 3B is a flow diagram illustrating an approach toward discarding malicious or suspect SUPL-INIT messages responsive to a UDP port of a mobile device operating in a closed or restricted state according to an embodiment. In FIG. 3B, malicious external user 356, similar to malicious external user 256 of FIG. 2, may be engaged in an attempt to surreptitiously obtain an estimated location of UE 300, or may be seeking to disable UE 300 by flooding one or more UDP ports, for example, of UE 300 with a large number of messages so as to overwhelm processing resources of UE 300. In embodiments, malicious external user 356 may operate outside of a cellular communications network perhaps at a relatively remote location from network device UE 300, such as in another state or province as UE 300 or, for example, in another country entirely. Additionally, malicious external user 356 may be operating, for example, a smartphone, tablet computing device, laptop or desktop computing device capable of communicating, via the Internet, for example, with UE 300.

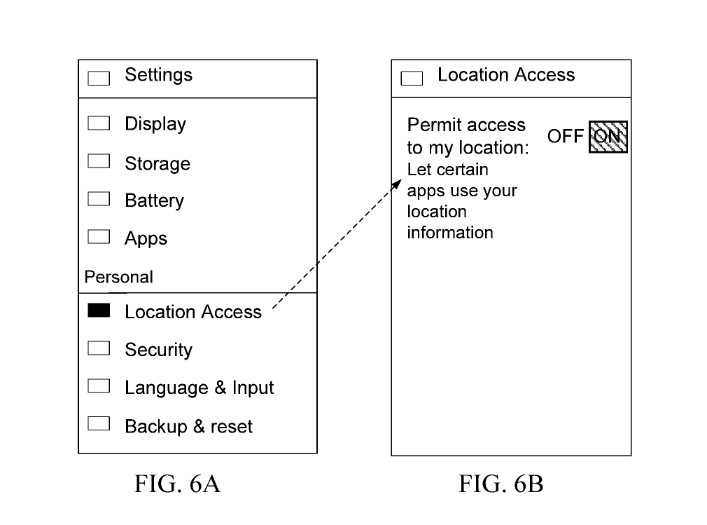

In the example of FIG. 3B, malicious user 356 may generate a SUPL INIT message, for example, in an attempt to instantiate a positioning session, so as to obtain a position estimate of UE 300. However, if UE 300 has been configured, such as via a “Settings” page rendered via a display of UE 300, such as described in reference to FIGS. 6A and 6B herein, malicious external user 356 may receive message 304, which may comprise, for example, an Internet Control Message Protocol (ICMP) message indicating that the destination UDP port is, for example, unreachable. Malicious external user 356 may receive additional messages, for example, or may receive other types of messages indicating an inability to communicate with UE 300, and claimed subject matter is not limited in this respect. It should be noted that communication between malicious external user 356 and UE 300 may take place utilizing one or more routers, such as local transceiver 115 of FIG. 1, and/or cellular transceiver 110, also of FIG. 1, and utilizing other elements, and claimed subject matter is not limited in this respect.

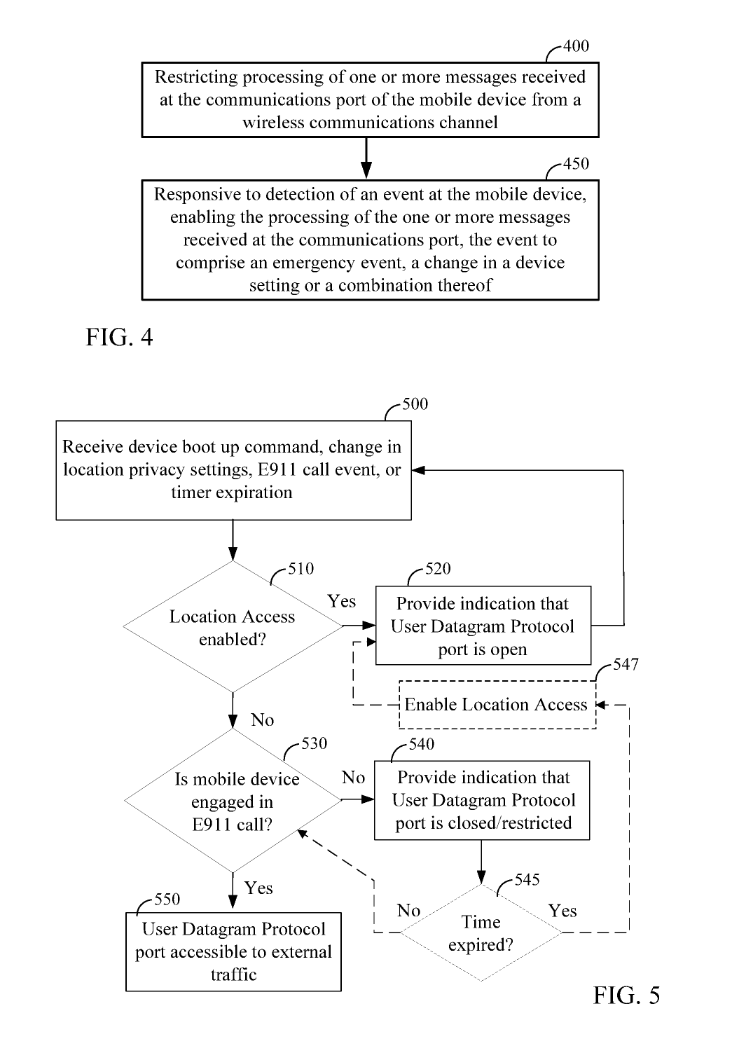

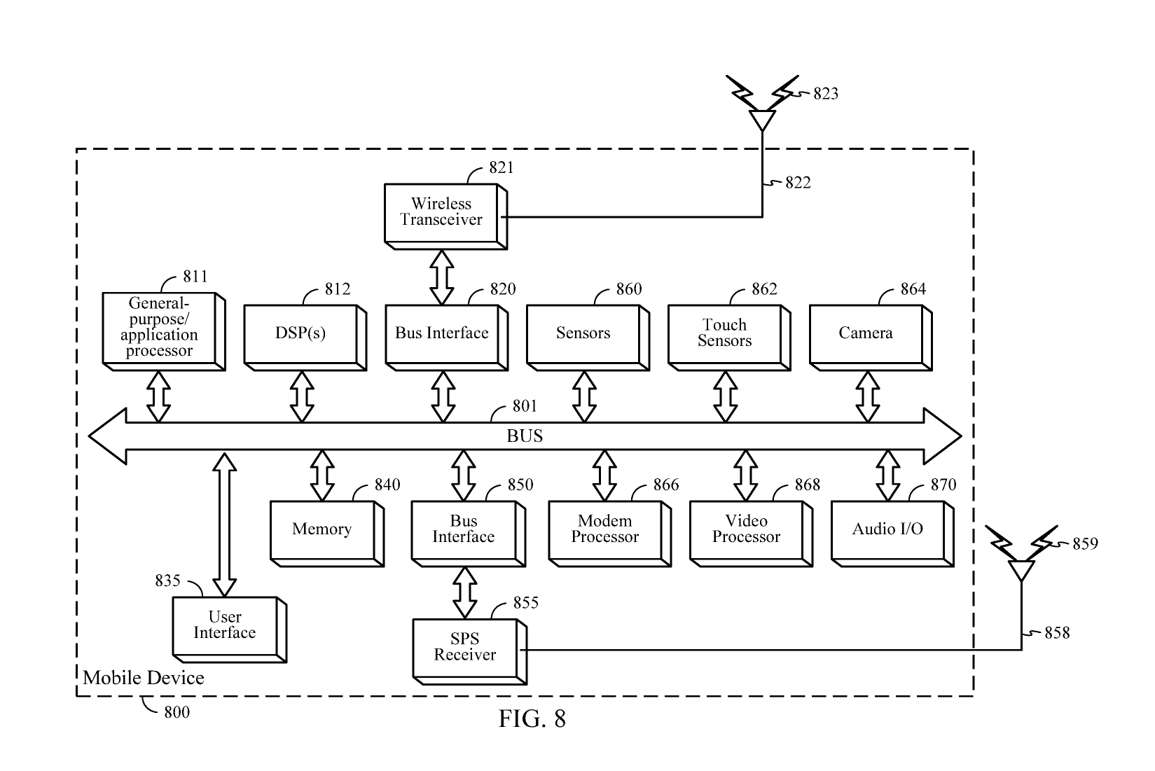

FIG. 4 is a flow diagram for a method to control external access to a communications port of a mobile device, such as mobile device 100, shown in FIG. 1. Example implementations, such as described in FIG. 4, and other figures described herein, may include blocks in addition to those shown and described, fewer blocks, or blocks occurring in an order different than may be identified, or any combination thereof. Block 400 of FIG. 1 may comprise restricting processing of one or more parameters received from a wireless communications channel via a communications port, which may be controllable, for example, at a user plane of the mobile device. Accordingly, a communications port, such as a controllable communications port, may correspond, for example, to a UDP port accessible at a user plane of a cellular communications network. In particular embodiments, the term “controllable port” or a “controllable communications port” may refer to a port that can be closed so as to preclude some types, or even all types, of messages from being processed by one or more processing units of a mobile device having access to the controllable port. A controllable port may also refer to a port for which access may be restricted so as to permit certain types of messages, such as, for example, messages comprising a particular header, to be processed by one or more processing units of the mobile device. In certain embodiments, a controllable port may refer to a port for which access may be restricted such that messages originating from locations outside of the cellular communications network, for example, may not be processed by one or more processing units of the mobile device, while messages originating from locations within the cellular communications network, for example, may be made available for processing by one or more processing units of a mobile device. In particular embodiments, block 400 may be performed by a general-purpose application processor operating in a mobile device, such as application processor 811, which may restrict processing of received parameters responsive to receipt of one or more electrical signals generated, for example, by user interface 835, as described further with regard to FIG. 8, herein.

Block 450 may comprise, responsive to detection of an event at the mobile device, removing a restriction on the processing of the one or more parameters received through a controllable port. Accordingly, in an embodiment, block 450 may correspond to opening, for example, a UDP port of a mobile device to external traffic. Thus, in one possible example, if one or more processors of a mobile device, such as a general-purpose application processor (e.g., application processor 811 of FIG. 8 herein) detects that a mobile device user has placed a telephone call requesting emergency services, such as via user interface 835 of FIG. 8, the one or more processors of the mobile device may remove restrictions on the processing of parameters received through a controllable port. Accordingly, a UDP port, for example, may be available to receive network-initiated messages via a user plane, such as a SUPL-INIT message, which may instigate a positioning session. A UDP port may be available to receive additional messages, such as network-initiated messages via a user plane, and claimed subject matter is not limited in this respect.

In another example embodiment, block 450 may correspond to opening a UDP port responsive to receipt of a device boot up command, which may also be received by way of user interface 835 of FIG. 8, for example. In another example, block 450 may correspond to opening a UDP port, for example, responsive to a user directly interacting with, for example, user interface 835 of FIG. 8 and to modify privacy settings of a mobile device, such as described with respect to FIG. 5 herein. In another example, block 450 may correspond to opening a UDP port, for example, responsive to expiration of a timer, which may permit a mobile device user to maintain location access privacy for a predetermined period of time, such as 5.0 min., 15.0 min., 30.0 min., one day, and so forth, as described with respect to FIG. 5 herein. In particular embodiments, block 450 may be performed utilizing a general-purpose application processor operating in a mobile device, such as application processor 811, which may operate responsive to receipt of one or more electrical signals generated, for example, by user interface 835, as described further with regard to FIG. 8, herein.

FIG. 5 is a flow diagram for a method of controlling external access to a communications port according to an embodiment. The method of FIG. 5 may be implemented, for example, utilizing a user interface cooperating with one or more processors (e.g. general purpose application processor 811 of FIG. 8) of a mobile device, such as mobile device 100 of FIG. 1, for example. As will be described further herein, particular blocks of the flow diagram of FIG. 5 may correspond to blocks 400 and 450 of FIG. 4. The method of FIG. 5 begins at block 500, in which, responsive to receiving a boot up command from a user interface, which may indicate a user powering-on a mobile device, one or more processors of a mobile device may determine, such as at block 510, if location access has been enabled. In some embodiments, in addition to, or in place of, receiving a boot up command from the user interface, block 500 may involve detecting a change in the location privacy settings, which may be received from a user interface of a mobile device, such as a user interface of FIG. 6A-6B, for example, or may involve detecting that a user has initiated a telephone call to an emergency-response number, such as E911, for example. Thus, at least in some embodiments, block 500 may represent an example of an “event” in the context of block 450 of FIG. 4.

Returning to FIG. 5, responsive to decision block 510, in which one or more processors of a mobile device may determine if location access has been enabled, a user interface of the mobile device may indicate a status of the UDP port as open to indicate that a UDP port is available to receive, for example, a SUPL-INIT message. If the decision of block 510 indicates that location access has not been enabled, block 530 may be executed, in which a processor of the mobile device may determine if the mobile device is presently engaged in an emergency telephone call, such as an E911 call, for example. If the decision of block 530 indicates that the mobile device is not engaged in, for example, an E911 call, block 540 may be executed in which a user interface of the mobile device may indicate a status of the UDP port as closed to indicate that a UDP port may not be available to receive, for example, a SUPL-INIT message.

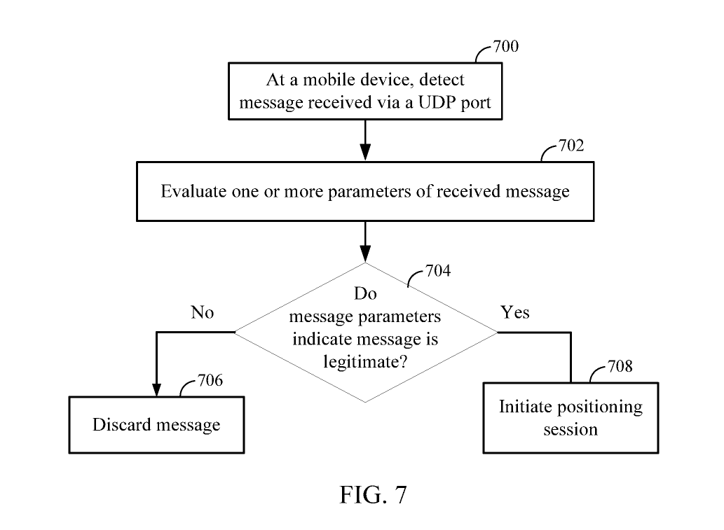

In a particular embodiment, rather than a user interface of a mobile device indicating that a UDP port of a mobile device is closed, a user interface may, instead, indicate that the UDP port is “restricted,” for example. In an embodiment, an indication that access to a UDP port is “restricted” may indicate, for example, that a mobile device may receive and/or process certain types of messages received via a UDP port while excluding certain other types of received messages from processing. For example, a UDP port of a mobile device may be configured to accept messages comprising particular parameters, such as one or more identifiers and/or codewords to indicate that the message is a legitimate SUPL-INIT message, and to discard messages that do not comprise predetermined identifiers and/or codewords, such as described in FIG. 7, herein. Returning to FIG. 5, if the decision of block 530 indicates that the mobile device is presently engaged in, for example, an E911 telephone call, block 550 may be executed in which a processor may open a UDP port, thereby permitting messages, such as a legitimate SUPL-INIT message, for example, to be received and processed by one or more processors of the mobile device. In an embodiment, opening a UDP port of the mobile device may be accompanied by an indication on a user interface that a UDP port is available to receive messages, such as a SUPL-INIT message, although claimed subject matter is not limited in this respect.

In particular embodiments, a mobile device may utilize an output signal from a timer to determine whether a UDP port, for example, is to return to an open state. Accordingly, as indicated at block 545, (shown in dotted lines in FIG. 5) if a timer has expired, location access may be re-enabled, such as at block 547. In some embodiments, the timer expiration of block 545 may represent an example of an “event” in the context of block 450 of FIG. 4. Responsive to re-enabling of the UDP port, such as at block 547, block 520 of FIG. 5 may be executed, in which a mobile device may provide an indication that the UDP port has been returned to an open state. If, however, the decision of block 545 indicates that a timer has not expired, block 530 may be executed, in which if the mobile device is presently engaged in, for example, an E911 call, block 550 may be executed. At block 550, a processor of a mobile device may open a UDP port, thereby permitting externally-generated messages, such as a legitimate SUPL-INIT messages, for example, to be received and processed by one or more processors of the mobile device. Thus, a mobile device user engaging in an E911 call may represent another example of an “event” in the context of block 450 of FIG. 4. If the mobile device is not presently engaged in, for example, an E911 call, block 540 may be executed in which a mobile device may indicate that a UDP port has been placed in to a closed/restricted state.

FIGS. 6A-6B are schematic diagrams of a display of a mobile device showing a location access selection and an indication showing status of a location access feature according to an embodiment. In FIG. 6A, a “Settings” page of a mobile device may provide a mobile device user with an ability to change user settings related to the device display, settings related to device storage, battery settings, available applications (Apps), location access, security, language and input and backup and reset options. In particular embodiments, one or more of such Apps may represent third-party applications, which may comprise computer-implemented instructions prepared by individuals or companies other than the provider of, for example, a mobile device. Additionally, in embodiments, a “Settings” page presented on a display of a mobile device may include numerous additional settings, customizations, device configuration options, and claimed subject matter is not limited to any particular implementation of a user interface, such as a Settings page. As shown in FIG. 6A, a “Location Access” setting has been selected, which may, for example, bring about display of a “Location Access” page, such as shown in FIG. 6B.

As shown in FIG. 6B, in a possible embodiment, a Location Access page may inform a user that by enabling Location Access, certain applications may obtain positioning parameters of the mobile device. In particular embodiments, positioning parameters may be obtained by way of transmitting a SUPL-INIT message, via a user plane, to the mobile device as described in regard to block 550 of FIG. 5, for example. In the embodiment of FIG. 6B, a mobile device user, for example, has selected to close or disable a UDP port, which may enable a mobile device user to change positions and to keep estimations of such positions private, as described with regard to block 540 of FIG. 5, for example. Closing or disabling a UDP port may bring about additional benefits, and claimed subject matter is not limited in this respect. In certain embodiments, as previously described, if a mobile device user places an emergency telephone call (e.g., E911) a Location Access indicator, such as shown in FIG. 6B may switch to an “on” state responsive to the call placement. Such switching of a UDP port to an “on” state responsive to placement of an emergency telephone call, for example, may correspond to block 550 of FIG. 5, for example, and claimed subject matter is not limited in this respect.

In an embodiment, selection of a “Location Access” setting of FIG. 6B may correspond to block 520 of FIG. 5, in which an indication may be provided that a UDP port has been placed in an “open” state. Selection of a “Location Access” may additionally represent an “event” of block 450 of FIG. 4, for example, comprising removal of restrictions on processing of parameters received through a controllable (e.g., UDP) port. Further, a user's selection to disable Location Access (e.g., by deselecting “Location Access” of FIG. 6A) may correspond to block 400 of FIG. 4, comprising restricting processing of parameters received through a controllable (e.g., UDP) port. Deselecting Location Access may additionally correspond, in an embodiment, to block 540 of FIG. 5, which comprises providing an indication that a user datagram protocol port is closed/restricted.

In particular embodiments, a selection to permit location access, such as previously described herein, may operate in a binary state in which, for example, a UDP port, of a mobile device, is either open or closed. In an open state, for example, all message traffic properly addressed to the UDP port may be received and processed by one or more processors of a mobile device. To the contrary, in a closed state, all message traffic addressed to the UDP port may be ignored and/or discarded so as to prevent one or more processors of a mobile device from processing received message traffic. However, in certain embodiments, a UDP port of a mobile device may be placed in a “restricted” state, in which, at least in one possible embodiment, a UDP port of a mobile device may be open to certain messages from external sources, such as messages comprising header information indicative of a SUPL-INIT message. Additionally, a UDP port placed in a restricted state may be closed to certain other messages from external sources, such as messages lacking header information indicative of a SUPL-INIT message or messages appearing to originate from locations outside of a cellular communications network. A “restricted” state of a UDP port of a mobile device may permit receipt of other classes of messages, and discard certain other classes of message types, and claimed subject matter is not limited in this respect.

FIG. 7 is a flow diagram for a method for controlling external access to a communications port according to an embodiment. The method of FIG. 7 may permit a mobile device, such as UE 300, of FIGS. 6A and 6B, or mobile device 100 of FIG. 1, to restrict external access to a connectionless port, such as a UDP port, for example. Accordingly, a mobile device may capable of appearing “open” to certain types of externally-generated messages, while remaining “closed” to certain other types of externally-generated messages. The method may begin at block 700, at which, a mobile device may detect presence of a message at a connectionless port, such as a UDP port. At block 702, one or more processors of a mobile device, such as application processor 811 of FIG. 8, may evaluate parameters, such as parameters embedded in a header, for example, of a received message. In particular embodiments, one or more processors of a mobile device (e.g., application processor 811 of FIG. 8) may evaluate a source parameter, which may be utilized to indicate the origin of a received message. At decision block 704, one or more processors of a mobile device may determine that parameters of a received message indicate, or at least are likely to indicate, that a received message has originated from a legitimate source within, for example, a cellular communications network. Responsive to a decision that a received message does not appear to have originated from a legitimate source, block 706 may be executed, in which the message may be discarded. Responsive to a decision that a received message does appear to have originated from a legitimate source, block 708 may be performed, in which a positioning session may be initiated.

FIG. 8 is a schematic diagram of a mobile device 800 such as a mobile device (e.g., mobile device 100), mobile station, UE (e.g., UE 300), subscriber equipment (SET) or Target device shown in FIG. 1-FIG. 3 according to an embodiment. In certain embodiments, mobile device 800 may comprise a wireless transceiver 821 which is capable of transmitting and receiving wireless signals 823 via wireless antenna 822 over a wireless communication network, for example, wireless transceiver 821 may be used to establish communication to an LS (e.g., LS 206) and/or other entities, via an eNB (e.g., eNB 205) and other network infrastructure. Wireless transceiver 821 may be connected to bus 801 by a wireless transceiver bus interface 820. Wireless transceiver bus interface 820 may, in some embodiments be at least partially integrated with wireless transceiver 821. Some embodiments may include multiple wireless transceivers 821 and wireless antennas 822 to enable transmitting and/or receiving signals according to corresponding multiple wireless communication standards such as, for example, versions of IEEE Std. 802.11, CDMA, WCDMA, LTE, UMTS, GSM, AMPS, ZigBee and Bluetooth, just to name a few examples.

Mobile device 800 may also comprise SPS receiver 855 capable of receiving and acquiring SPS signals 859 via SPS antenna 858. SPS receiver 855 may also process, in whole or in part, acquired SPS signals 859 for estimating a location of mobile device 800. In some embodiments, general-purpose processor(s) 811, memory 840, DSP(s) 812 and/or specialized processors (not shown) may also be utilized to process acquired SPS signals, in whole or in part, and/or calculate an estimated location of mobile device 800, in conjunction with SPS receiver 855. Storage of SPS or other signals (e.g., signals acquired from wireless transceiver(s) 821) for use in performing positioning operations may be performed in memory 840 or registers (not shown). As such, general-purpose processor(s) 811, memory 840, DSP(s) 812 and/or specialized processors may provide a positioning engine for use in processing measurements to estimate a location of mobile device 800.

Also shown in FIG. 8, mobile device 800 may comprise digital signal processor(s) (DSP(s)) 812 connected to the bus 801 by a bus interface 810, general-purpose processor(s) 811 connected to the bus 801 by a bus interface 810 and memory 840. Bus interface 810 may be integrated with the DSP(s) 812, general-purpose processor(s) 811 and memory 840. In various embodiments, functions may be performed in response execution of one or more machine-readable instructions stored in memory 840 such as on a computer-readable storage medium, such as RAM, ROM, FLASH, or disc drive, just to name a few example. The one or more instructions may be executable by general-purpose processor(s) 811, specialized processors, or DSP(s) 812. Memory 840 may comprise a non-transitory processor-readable memory and/or a computer-readable memory that stores software code (programming code, instructions, etc.) that are executable by processor(s) 811 and/or DSP(s) 812 to perform functions described herein.

Also shown in FIG. 8, a user interface 835 may comprise any one of several devices such as, for example, a speaker, microphone, display device, vibration device, keyboard, touch screen, just to name a few examples. User interface may instead be supported via TCP/IP or other means to a remote user (e.g. a user accessing an HMS). In a particular implementation, user interface 835 may enable a user or an O&M system such as an HMS to interact with one or more applications hosted on mobile device 800. For example, devices of user interface 835 may store analog or digital signals on memory 840 to be further processed by DSP(s) 812 or general purpose processor 811 in response to action from a user. Similarly, applications hosted on mobile device 800 may store analog or digital signals on memory 840 to present an output signal to a user.

Mobile device 800 may also comprise environment sensors 860, such as for example, temperature sensors, barometric pressure sensors, ambient light sensors, camera imagers, microphones, just to name few examples. Sensors 860 may generate analog or digital signals that may be stored in memory 840 and processed by DSP(s) 812 or general purpose application processor 811 in support of one or more applications such as, for example, applications directed to positioning or navigation operations. Sensors 860 may be used to help determine the location of mobile device 800 and/or to provide information to a HNB management system (HMS) or standalone serving mobile location center (SAS) to assist in determining location of UEs.

In a particular implementation, mobile device 800 may comprise a dedicated modem processor 866 capable of performing baseband processing of signals received and down converted at wireless transceiver 821 or SPS receiver 855. Similarly, modem processor 866 may perform baseband processing of signals to be up converted for transmission by wireless transceiver 821. In alternative implementations, instead of having a dedicated modem processor, baseband processing may be performed by a general purpose processor or DSP (e.g., general purpose/application processor 811 or DSP(s) 812). It should be understood, however, that these are merely examples of structures that may perform baseband processing, and that claimed subject matter is not limited in this respect.

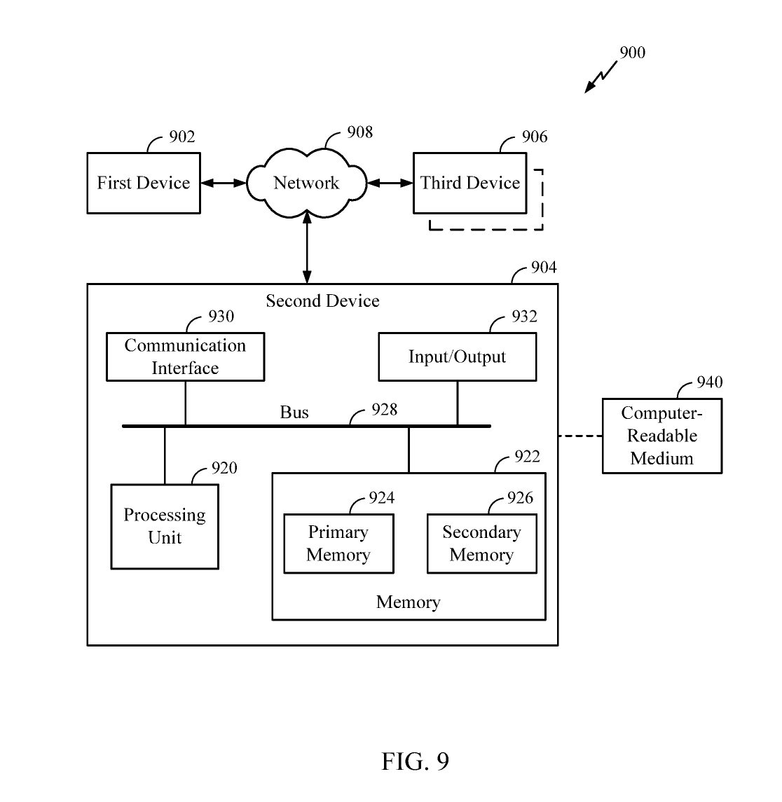

FIG. 9 is a schematic diagram illustrating an example system 900 that may include one or more devices configurable to execute the methods described, for example, in FIGS. 4 and 5. System 900 of FIG. 9 may include, for example, a first device 902, a second device 904, and a third device 906, which may be operatively coupled together through a wireless communications network 908. In an aspect, second device 904 may comprise a server such as an MME, E-SMLC, GMLC, LRF, PSAP, LS or E-SLP as depicted in FIG. 2. Also, in an aspect, wireless communications network 908 may comprise one or more wireless access points, for example.

First device 902, second device 904 and third device 906, as shown in FIG. 9, may be representative of any device, appliance or machine that may be configurable to exchange data over wireless communications network 908. By way of example but not limitation, any of first device 902, second device 904, or third device 906 may include one or more computing devices or platforms, such as a desktop computer, a laptop computer, a workstation, a server device, or the like. Any of first device 902, second device 904, or third device 906 may include one or more personal computing or communication devices or appliances, such as a personal digital assistant, mobile communication device, or the like. Any of first device 902, second device 904, or third device 906 may include a computing system or associated service provider capability, such as a database or data storage service provider/system, a network service provider/system, an Internet or intranet service provider/system, a portal or search engine service provider/system, a wireless communication service provider/system, or any combination thereof. Any of the first, second, and third devices 902, 904, and 906, respectively, may comprise one or more of a base station almanac server, a base station, or a mobile device in accordance with the examples described herein.

Similarly, wireless communications network 908 (e.g., in a particular of implementation of network 130 shown in FIG. 1), may be representative of one or more communication links, processes, or resources configurable to support the exchange of data between at least two of first device 902, second device 904, and third device 906. By way of example but not limitation, wireless communications network 908 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 906, there may be additional like devices operatively coupled to wireless communications network 908.

It is recognized that all or part of the various devices and networks shown in system 900, and the processes and methods as further described herein, may be implemented using or otherwise including hardware, firmware, software, or any combination thereof.

Thus, by way of example but not limitation, second device 904 may include at least one processing unit 920 that is operatively coupled to a memory 922 through a bus 928. Processing unit 920 is representative of one or more circuits configurable to perform at least a portion of a data computing procedure or process. By way of example but not limitation, processing unit 920 may include one or more processors, controllers, microprocessors, microcontrollers, application specific integrated circuits, digital signal processors, programmable logic devices, field programmable gate arrays, and the like, or any combination thereof.

Memory 922 is representative of any data storage mechanism. Memory 922 may include, for example, a primary memory 924 or a secondary memory 926. Primary memory 924 may include, for example, a random access memory, read only memory, etc. While illustrated in this example as being separate from processing unit 920, it should be understood that all or part of primary memory 924 may be provided within or otherwise co-located/coupled with processing unit 920.

In a particular implementation, a digital map of an indoor area may be stored in a particular format in memory 922. Processing unit 920 may execute instructions to processes the stored digital map to identify and classify component areas bounded by a perimeter of structures indicated in the digital map. As pointed out above, these executed instructions may specify identifying and characterizing egress segments in structures forming a perimeter bounding a component area and classifying the bounded component area based, at least in part, on a proportionality of a size of at least one identified egress segment to a size of at least one dimension of the bounded component area.

Secondary memory 926 may include, for example, the same or similar type of memory as primary memory or one or more data storage devices or systems, such as, for example, a disk drive, an optical disc drive, a tape drive, a solid state memory drive, etc. In certain implementations, secondary memory 926 may be operatively receptive of, or otherwise configurable to couple to, a computer-readable medium 940. Computer-readable medium 940 may include, for example, any non-transitory medium that can carry or make accessible data, code or instructions for one or more of the devices in system 900. Computer-readable medium 940 may also be referred to as a storage medium.

Second device 904 may include, for example, a communication interface 930 that provides for or otherwise supports the operative coupling of second device 904 to at least wireless communications network 908. By way of example but not limitation, communication interface 930 may include a network interface device or card, a modem, a router, a switch, a transceiver, and the like.

Second device 904 may include, for example, an input/output device 932. Input/output device 932 is representative of one or more devices or features that may be configurable to accept or otherwise introduce human or machine inputs, or one or more devices or features that may be configurable to deliver or otherwise provide for human or machine outputs. By way of example but not limitation, input/output device 932 may include an operatively configured display, speaker, keyboard, mouse, trackball, touch screen, data port, etc.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, microcontrollers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, bytes, values, elements, symbols, characters, terms, numbers, numerals, expressions, messages, fields, identifiers frames, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a cellular transceiver device, utilized to extend cellular telephone service into a business or home. In such an implementation, one or more mobile devices may communicate with a cellular transceiver device via a code division multiple access (“CDMA”) cellular communication protocol, for example.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

1. A method to control external access to a communications port at a mobile device, comprising:
restricting, at the mobile device, an ability to transmit positioning parameters over the communications port in response to processing of one or more messages received at the communications port of the mobile device from a wireless communications channel; and
responsive to detection of an event at the mobile device, enabling transmission of the positioning parameters over the communications port, the event to comprise an emergency event, a change in a device setting or a combination thereof.

2. The method of claim 1, further comprising:
closing the communications port to message traffic originating from outside of a cellular communications network.

3. The method of claim 1, wherein the communications port is configurable to initiate communications with a cellular communications network utilizing a connectionless protocol.

4. The method of claim 3, wherein the connectionless protocol is based, at least in part, on a User Datagram Protocol accessible at a user plane of the mobile device.

5. The method of claim 1, further comprising:
closing the communications port based, at least in part, on evaluating at least one parameter of the one or more messages received from the wireless communications channel.

6. The method of claim 1, wherein the event comprises the emergency event, the emergency event comprising obtaining a signal from a user interface to indicate a telephone call to an emergency services provider.

7. The method of claim 1, wherein the change in the device setting is responsive to obtaining a signal from a user interface, the signal to indicate an instruction to permit transmission of the positioning parameters over the communications port.

8. The method of claim 1, wherein the change in the device setting is responsive to obtaining a signal from a user interface of a third party application hosted on the mobile device.

9. The method of claim 8, wherein the change in the device setting is responsive to obtaining a signal from a user interface to enable location access by one or more network elements via the wireless communications channel.

10. The method of claim 9, wherein the network element generates a Secure User Plane Location-Initiate (SUPL-INIT) message.

11. The method of claim 1, wherein the change in the device setting is responsive to obtaining a boot up command from a user interface of the mobile device.

12. The method of claim 1, wherein the change in the device setting is responsive to expiration of a timer.

13. A mobile device to support location services, comprising:
a transceiver device to wirelessly receive messages from and to transmit messages to a communications network; and
one or more processors coupled to the transceiver device and configured to:
initiate one or more restrictions on an ability to transmit positioning parameters over a communications port in response to processing of the messages received by the transceiver device from a wireless communications channel via the communications port of the mobile device; and
initiate removal of the one or more restrictions on the ability to transmit the positioning parameters over the communications port based, at least in part, on detection of an event at the mobile device, the event to comprise an emergency event, a change in a device setting or a combination thereof.

14. The mobile device of claim 13, wherein the one or more restrictions on the ability to transmit the positioning parameters is based, at least in part, on whether the received messages indicate that the received message has originated from outside of a cellular communications network.

15. The mobile device of claim 13, wherein the emergency event corresponds to receipt of a signal from a user interface to indicate a user telephone call to an emergency services provider.

16. The mobile device of claim 13, wherein the communications port utilizes a connectionless protocol to initiate a communication session at a user plane.

17. The mobile device of claim 16, wherein the communications port comprises a User Datagram Protocol port.

18. The mobile device of claim 13, wherein one or more of the received messages comprises a Secure User Plane Location-Initiate (SUPL-INIT) message.

19. The mobile device of claim 13, wherein the one or more processors are further configured to:
determine that the received messages from the wireless communications channel originate from a legitimate source based, at least in part, on an evaluation of at least one parameter of the received messages.

20. A mobile device to control external access to a communications port, comprising:
means for restricting an ability to transmit positioning parameters over the communications port in response to processing of one or more messages received from a wireless communications channel at the communications port of the mobile device; and
means for removing restrictions on the ability to the transmit positioning parameters based, at least in part, on detection of an event at the mobile device, the event to comprise an emergency event, a change in a device setting or a combination thereof.

21. The mobile device of claim 20, wherein the means for restricting the ability to transmit positioning parameters comprises means for closing the communications port to message traffic to originate from outside of a cellular communications network.

22. The mobile device of claim 20, further comprising:
means for evaluating at least one parameter of the one or more messages received from the wireless communications channel.

23. The mobile device of claim 20, wherein the means for removing restrictions comprises means for receiving a signal from a user interface to enable location access and wherein the signal from a user interface is responsive to a user command to boot up the mobile device.

24. The mobile device of claim 20, further comprising:
means for responding to a Secure User Plane Location-Initiate (SUPL-INIT) message.

25. The mobile device of claim 20, wherein the communications port of the mobile device comprises a User Datagram Protocol port.

26. A non-transitory storage medium comprising instructions executable by a special-purpose computing apparatus of a mobile device to:
restrict an ability to transmit positioning parameters over a communications port in response to processing of one or more messages received at the mobile device from a wireless communications channel at a communications port of the mobile device; and
responsive to detection of an event at the mobile device, remove the restriction on the ability to transmit the positioning parameters over the communications port, the event to comprise an emergency event, a change in a device setting or a combination thereof.

27. The non-transitory storage medium of claim 26, further comprising instructions executable by a special-purpose computing apparatus to:
utilize a connectionless protocol to receive the one or more messages from the wireless communications channel via the communications port of the mobile device.

28. The non-transitory storage medium of claim 26, wherein the communications port of the mobile device comprises a User Datagram Protocol port, and wherein the one or more received messages correspond to Secure User Plane Location-Initiation (SUPL-INIT) messages.

29. The non-transitory storage medium of claim 26, wherein the event corresponds to receipt of a signal from a user interface, the signal from the user interface to enable location access by one or more network elements.

30. The non-transitory storage medium of claim 26, further comprising instructions executable by a special-purpose processor to:
determine that the one or more messages received from the wireless communications channel originate from a legitimate source based, at least in part, on an evaluation of at least one parameter of the one or more messages.
